(19) United States
(12) Patent Application Publication
(10) Pub. No.: US 2023/0115412 A1
(43) Pub. Date: Apr. 13, 2023

(54) MARKETING BUDGET ALLOCATION IN A DATA ANALYTICS SYSTEM

(71) Applicant: The Boston Consulting Group, Inc., Boston, MA (US)

(72) Inventors: David Aurélien Camille Galley, Paris (FR); Priscille Marie Françoise BOISSONNET, Paris (FR); Guillaume Louis Jean PLESSIX, Paris (FR); Alexandre Marc Jean Lainé, Paris (FR); Henri François Louis VIGUIER, Paris (FR); o Amélie Martine Eulalie MEURER, Neuilly-sur-Seine (FR); Matthieu Charpy, Carrières-sur-Seine (FR); Lucie Estelle Pauline Allain, Paris (FR); Abel-Edouard ESSIANE, London (GB); Jessica Apotheker, Paris (FR); Nicolas Pissonnet De Bellefonds, Paris (FR)

(21) Appl. No.: 17/722,225

(22) Filed: Apr. 15, 2022

Related U.S. Application Data
(60) Provisional application No. 63/254,963, filed on Oct. 12, 2021.

(51) Int. Cl. G06Q 30/02

(52) U.S. Cl. CPC G06Q 30/0201

(57) ABSTRACT

Methods, systems, and computer storage media for providing a marketing budget allocation service associated with an optimization and simulation engine in a data analytics system. The marketing budget allocation service is a marketing expenditure optimization service that provides marketing budget allocation intelligence and visualizations based on data analysis and business information (e.g., prior hypothesis input data or scenario input data). The marketing budget allocation service is based on a service pipeline that includes a set of allocation intelligence data processors and operations that are used to generate output that is managed (e.g., visualized, presented, and revised) using a data analytics user interface. In operation, based on analyzing marketing budget allocation data—via an allocation service analytics computation model, marketing budget allocation results data are generated. The marketing allocation results data are communicated to cause presentation of the marketing budget allocation results data on an optimization and simulation engine user interface.

### CROSS-REFERENCE SECTION

The present application claims the benefit of U.S. Provisional Application No. 63/254,963, filed Oct. 12, 2021 and entitled “MARKETING BUDGET ALLOCATION IN A DATA ANALYTICS SYSTEM”, the entirety of which is incorporated by reference herein.

### BACKGROUND

Many companies rely on data analytics systems for computational analysis of data or statistics to discover, interpret, and communicate important patterns in data. Data analytics systems implement predictive analysis (e.g., a forecasting system) and machine learning that analyze current and historical facts to make predictions about future events. For example, a business predictive model may analyze historical and transactional data to identify risks and opportunities. A data analytics system can operate based different types of datasets to facilitate business analytics based computational models and performing predictive analysis. For example, a dataset can be used in a marketing services application, where the dataset includes marketing touchpoints associated with customers, accounts, and transactions.

Conventionally, data analytics systems are not configured with a computing infrastructure and logic to intelligently optimize marketing budget allocation and efficiently scale based on probabilistic programming operations associated with business input data. In particular, market spend allocation tools and corresponding operations rely on black box computing or heavily manually corrected implementations, that result in limited transparency, understanding, interactivity with the results data. For example, an estimation methodology can include several manual steps and human intervention in the estimation process. Such methods are inefficient and cannot scale to support different types of marketing budgets, brands, and products. As such, a more comprehensive data analytics systems—having an alternative basis for providing marketing budget data analytics systems operations—can improve computing operations and interfaces in data analytics systems.

### SUMMARY

Various aspects of the technology described herein are generally directed to systems, methods, and computer storage media, for among other things, providing a marketing budget allocation service associated with an optimization and simulation engine in a data analytics system. Marketing budget allocation includes identifying an amount of a budget per product (or brand) and touchpoints—ways a business interacts with (potential) customers—that maximize financial key performance indicators (KPIs) (e.g., volume, sales, margin) under certain business constraints (e.g., budget, cost, market evolutions, consumer behaviors, and strategic intent). In this way, the marketing budget allocation service is a marketing expenditure optimization service that provides marketing budget allocation intelligence and visualizations based on data analysis and business information (e.g., prior hypothesis input or scenario input data). The marketing budget allocation service is based on a service pipeline that includes a set of allocation intelligence data processing engines that are used to generate output that is managed (e.g., visualized, presented, and revised) using a data analytics user interface.

Operationally, the marketing budget allocation service is provided—via a data analytics engine—based on a data ingestion engine, a response curve generator, a long-term impact correction engine, an optimization and simulation engine and a data analytics user interface. The data ingestion engine is configured to connect to different datasets. Business hypothesis input data is received at the market budget allocation service, and based on marketing data in the datasets and the business hypothesis input data, the response curve generator generates—using probabilistic programming operations—return on investment (ROI) report data associated with a plurality of touchpoints of a product or brand.

The long-term correction engine supports factoring an impact on long-term sales of each touchpoint, while the response curve generator is focused on short-term sales. The optimization and simulation engine receives optimization and simulation input data (e.g., quantified strategic objectives and business constraints) that are used to run scenarios, where the output can be presented and interacted with via the data analytics user interface. For example, users can run marketing budget investment scenarios and compare them via the data analytics user interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary data analytics system with a marketing budget allocation, in which embodiments described herein may be employed;

FIGS. 1C-1E are schematics associated with a data analytics system with a marketing budget allocation, in which embodiments described herein may be employed;

FIGS. 2A and 2B are block diagrams of an exemplary data analytics system with a marketing budget allocation, in which embodiments described herein may be employed;

FIGS. 2C-2M are schematics associated with a data analytics system with a marketing budget allocation, in which embodiments described herein may be employed;

FIG. 3 is a flow diagram showing an exemplary method for implementing a data analytics system with a marketing budget allocation, in accordance with embodiments described herein;

FIG. 4 is a flow diagram showing an exemplary method for implementing a data analytics system with a marketing budget allocation, in accordance with embodiments described herein;

FIG. 5 is a flow diagram showing an exemplary method for implementing a data analytics system with a marketing budget allocation, in accordance with embodiments described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION OF THE INVENTION

### Overview

By way of background, a data analytics system can support performing computational analysis of data or statistics to discover, interpret, and communicate important patterns in data. Many companies (e.g., retail, manufacturing, travel, construction) implement data analytics systems to gather, monitor, track, model, and deploy data-driven insights to create competitive advantages. Data analytics can include business analytics that includes iterative explorations and investigations of past business performance to gain insights and drive business planning. In particular, business analytics data processing engines can include processing operations that can improve business analytics output.

By way of example, companies spend money on different marketing touchpoints. Marketing touchpoints can refer to any methods or modes of contact between a company and the consumer or customer. Touchpoints can be television, digital or in-store trade activities, face-to-face discussions, promotional flyers, online ads, and anything else that involves a business marketing message, or brand name. Companies operate more efficiently when there exists a financial plan—(e.g., for a defined period of time)—that expresses strategic plans of marketing activities or events in measurable terms. For example, a budget can be the sum of finances allocated for a particular purpose and a summary of intended expenditures along with proposals for how to meet them. Budgets can be generated based on estimation analysis, where estimation analysis includes estimation statistics—a data analysis framework—that uses a combination of effect sizes, confidence intervals, precision planning and meta-analysis to plan experiments, analyze data and interprets results. In this way, a company can estimate the impact of its investment on different touchpoints—assessing the changes that can be attributed to specific touchpoints—especially expenditures of volumes of different brands or products of a particular company. As used herein, the term brand contemplates products (e.g., a product with a stock keeping unit (SKU) or a group of SKUs, a brand, a category or any aggregation of products). And, as described in more detail below, marketing budget allocation results data—with embodiments of this invention—can include recommendations by channel (e.g., retail stores versus e-commerce) and geographical region (e.g., city, stats, country). This allocation of spend can be associated with a product, channel, and geographical region (e.g., Nike Air Force One, retail, and New York City).

Conventionally, it can be challenging to find adequate tools that support transparent and scalable marketing budget allocation. For example, external providers of budgeting services may implement an estimation methodology that is not shared, thus limiting the ability for a company (i.e., a customer of the budgeting services tool) to challenge the results or recommendations. Moreover, substantial manual work may be needed to perform some estimation methodologies, which limits the ability to scale (i.e., lack of scalability) such solutions and use the solutions repeatedly. In addition, with some external providers of budgeting services, the results provided via their estimation tools are merely insights that lack action items associated with quantified and measurable data. Finally, estimation methods often include exclusively a snapshot view of the solution at the time the analysis was performed and do not account for different types of projected data as input data.

Moreover, data analytics systems are not configured with a computing infrastructure and logic to intelligently optimize marketing budget allocation and efficiently scale based on probabilistic programming operations associated with business input data. In particular, market spend allocation tools and corresponding operations rely on black box or heavily manually corrected computing implementations, that result in limited transparency, understanding, and interactivity with the results data. For example, an estimation methodology can include several manual steps and human intervention in the estimation process. Such methods are inefficient and cannot scale to support different types of marketing budgets, brands, products and geographies. As such, a more comprehensive data analytics systems—having an alternative basis for providing marketing budget data analytics systems operations—can improve computing operations and interfaces in data analytics systems.

Embodiments of the present disclosure are directed to systems, methods, and computer storage media, for among other things, providing a marketing budget allocation service associated with an optimization and simulation engine in a data analytics system. The marketing budget allocation service is a marketing expenditure optimization service that provides marketing budget allocation intelligence and visualizations based on data analysis and business information (e.g., business hypothesis input data, allocation service analytics computation model, or optimization and simulation input data). As used herein, budget broadly contemplates an amount of spend, expenditure, or investment. Budget can be associated with an identified period of time (e.g., month, quarter, year or multiple years).

The marketing budget allocation service is based on a service pipeline that includes a set of allocation intelligence data processors that are used to generate output that is managed (e.g., visualized, presented, and revised) using a data analytics user interface. At a high level, the marketing budget allocation service is provided via a marketing budget allocation engine implements a service pipeline that supports automated processing associated with holistic approach to budget marketing budget allocation operations. In particular, automated processing removes the need for manual checks and the holistic approach includes managing different touchpoints (marketing, trade, consumer incentives) and integrating a long-term impact view to decisions. Advantageously, the marketing budget allocation engine provides scalability, transparency, and democratization of a data analytics system.

Operationally, the marketing budget allocation service is provided—via a data analytics engine—based on a data ingestion engine, a response curve generator, a long-term impact correction engine, an optimization and simulation engine and a data analytics user interface. The data ingestion engine is configured to connect to different datasets. The data ingestion engine operates based on a flexible data model and a data loader that facilitates using the marketing budget allocation service across multiple industries. The flexible data model can be associated with a model builder that simplifies the syntax to build different types of models for processing and loading data into the marketing budget allocation service. Additionally, automated checks of model convergence, automated checks of results quality, and campaign planning features can also be performed based on the flexible data model.

Machine learning approaches can support the marketing budget allocation engine to further allow learning from data and improving analysis. Operationally, developing a machine learning model for the allocation service can be performed via a machine learning engine that supports gathering training data, defining goals and metrics associated with training data features or attributes (e.g., product features, budget features, marketing features, etc.) Datasets can include market budget allocation data associated with marketing budget allocation features that are used in the marketing budget allocation service. The marketing budget allocation features of the marketing budget allocation service are used by different components (e.g., data ingestion engine, a response curve generator, a long-term impact correction engine, an optimization and simulation engine) of the marketing budget allocation service to support the functionality described herein. A feature can refer to an individual measurable property or characteristic of a phenomenon of marketing budget allocation data. As such, the allocation service analytics computation model can include statistical models and machine learning models that operate based on the marketing budget allocation data features, where features are selected to be informative, discriminating for effective algorithms in pattern recognition, classification and regression. Features can be numeric or structural features such as strings and graphs are used in syntactic pattern recognition. The concept of feature is related to that of explanatory variables used in statistical techniques such as linear regression.

Machine learning techniques can include Long Short-Term Memory (LSTM), Random Forest, and Linear Regression to develop forecasting models. For example, a linear regression approach can help predict future values from past values based on identifying underlying trends, so using historical data, additional information about the specific product, discounts, and average market cost, a prediction of a future value can be provided as a recommendation. The machine learning engine can further support training the allocation service models (i.e., using historical data and algorithms), validation (i.e., optimizing forecasting model parameters and hyper-parameters), and deployment (e.g., integration into production use).

Business hypothesis input data is received at the market budget allocation service, and based on marketing data (e.g., marketing budget allocation features) in the datasets and the business hypothesis input data, the response curve generator generates—using probabilistic programming operations—return on investment (ROI) report data associated with a plurality of touchpoints of a brand. The ROI report data can specifically include ROI curves per unit of a selected currency (e.g., euro or dollar) spent—which operates as an indication of how much incremental volumes result from an additional unit of currency on each touchpoint or brand.

In some implementations, the response curve generator leverages probabilistic programming associated with statistical modeling, probabilistic modeling (e.g., Bayesian modelling), or machine learning. By way of illustration, the main output of the response model, response curves are the pairs of points (spend, incremental volume) for a specific brand and touchpoint pair, allowing to build the incremental volume due to different levels of spend. By default, response curves are defined as the incremental volume response to spend, but it can also be the response in revenue, or in financial metrics such as ROI. The mathematical framework of the response curve generator solves several issues from the conventional least-of-square models, and advantageously, it is used to support scalability and non-overly technical graphical user interface for interactive modeling. Moreover, by providing the business hypothesis input data, this obviates the burden of manual selection of data or results via the marketing budget allocation engine and support transparency on the hypotheses. The long-term correction engine supports factoring an impact on long-term sales of each touchpoint, while the response curve generator is focused on short-term sales.

The optimization and simulation engine receives optimization and simulation input data (e.g., quantified strategic objectives and business constraints) that are used to run scenarios, where the output can be presented and interacted with via the data analytics user interface. For example, users can run scenarios and compare them via the data analytics user interface. The optimization and simulation engine leverages a Mixed Integer Programming framework, allowing the marketing budget allocation service to maximize different objectives (e.g., volume, sales, margin) and integrate all constraints from clients (e.g., min/max budget, split media/trade). A clear advantage of this method compared to classical optimization methods (e.g., Linear Programming or Heuristics) is that Mixed Integer Programming can handle non-convex problems and still provide guarantees of optimality.

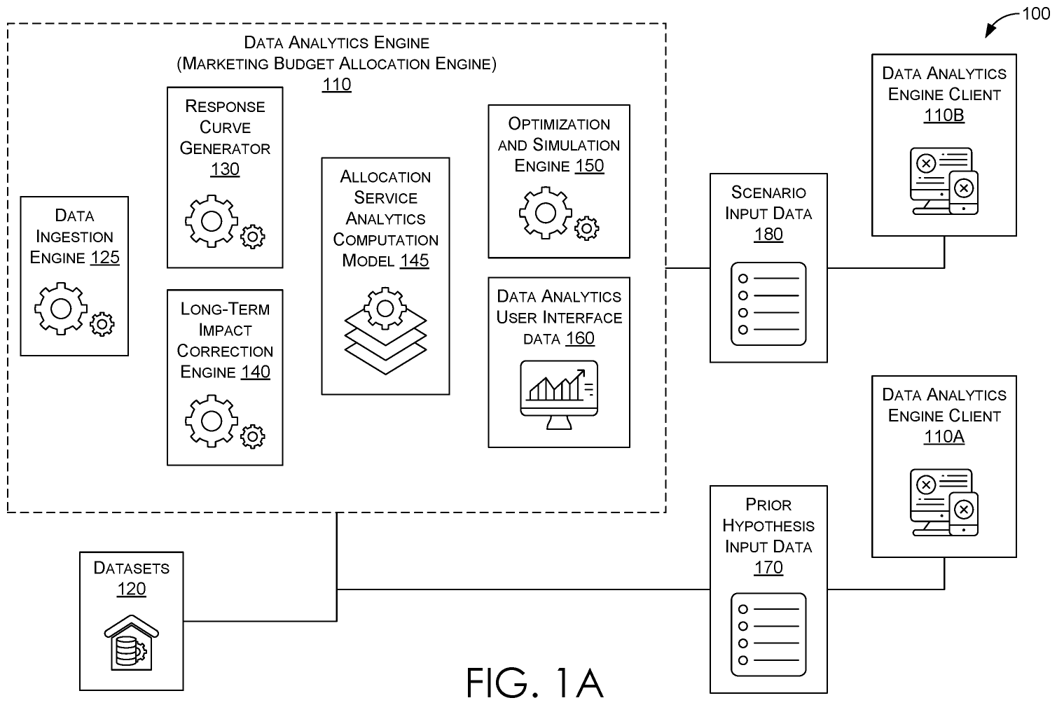

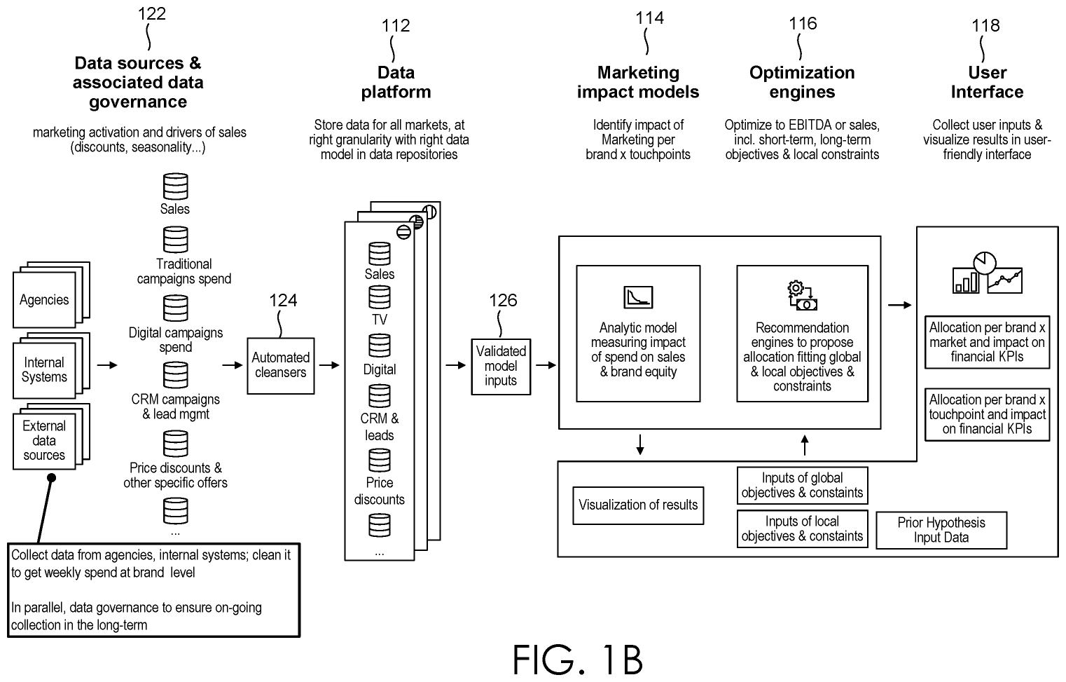

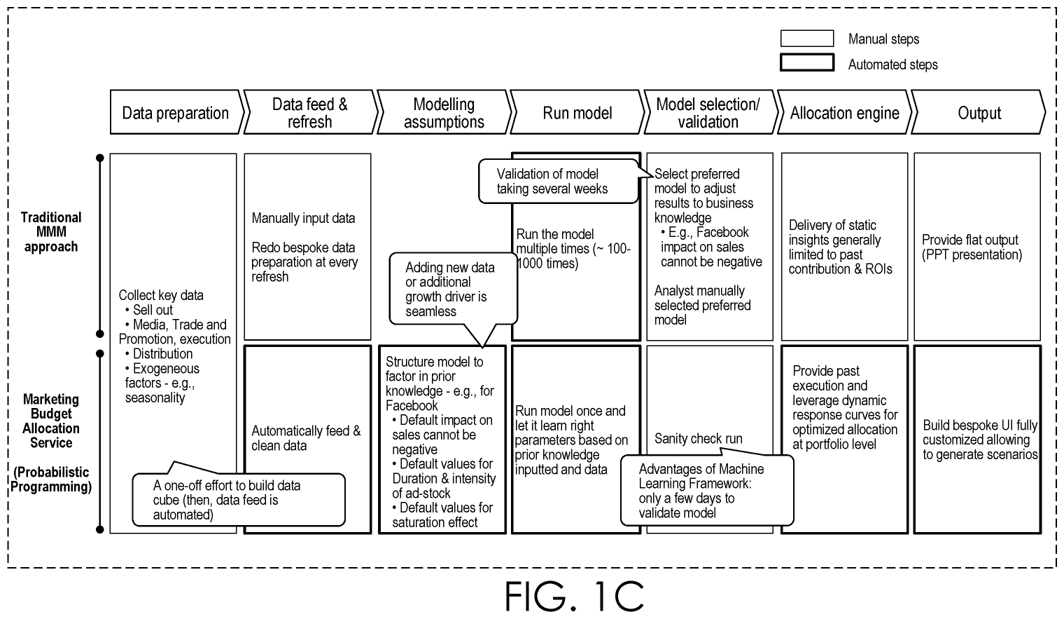

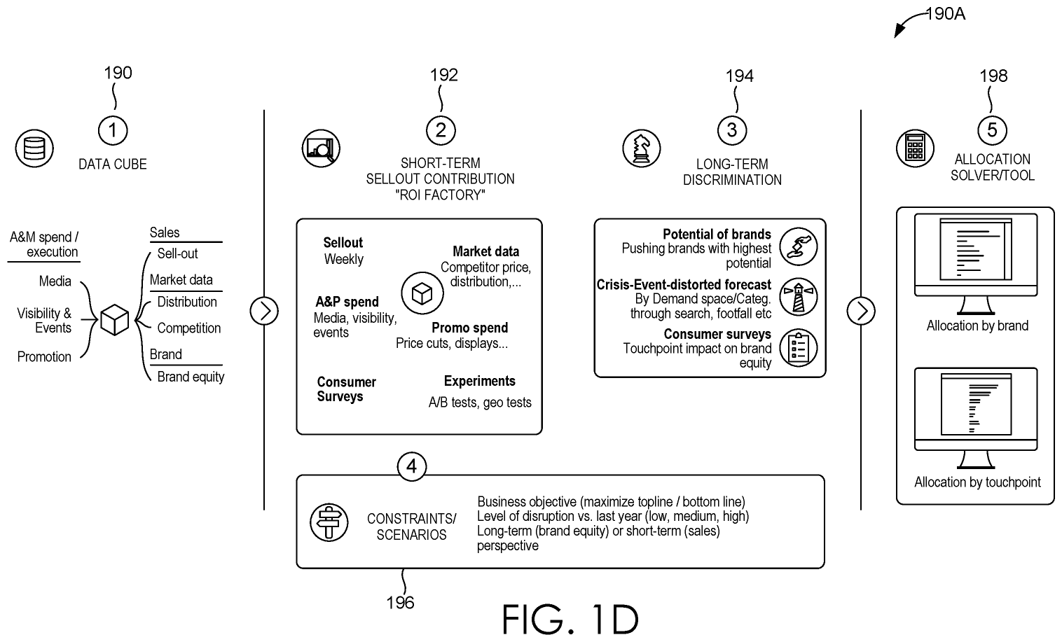

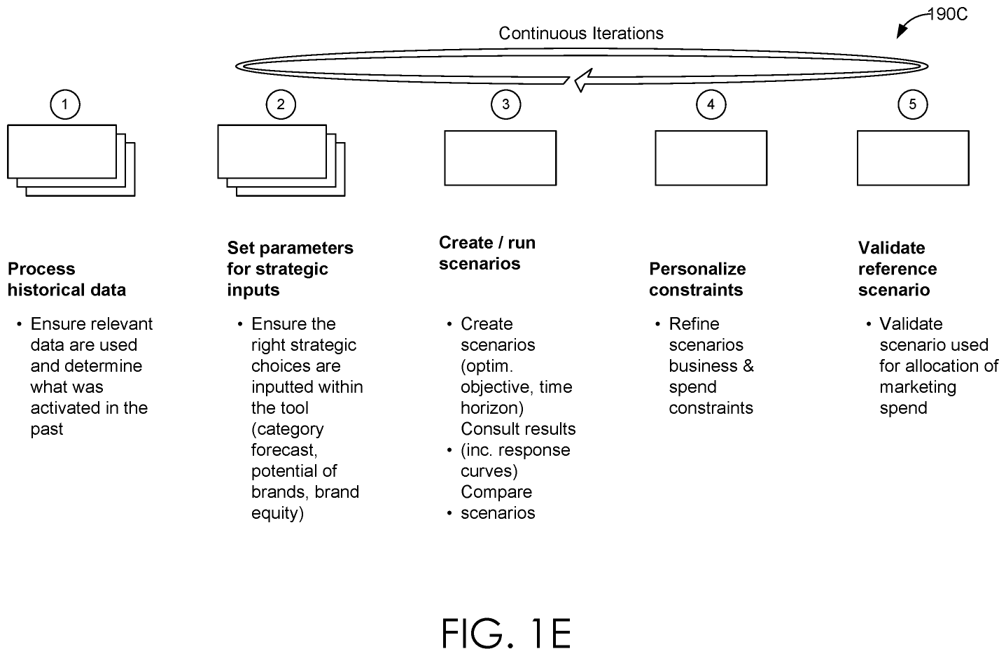

Aspects of the technical solution can be described by way of examples and with reference to FIGS. 1A-1E. FIG. 1A illustrates a data analytics system 100 including data analytics engine 110 (i.e., marketing budget allocation engine 110), data analytics engine client 110A, and data analytics engine client 110B, and datasets 120. The data analytics engine 110 further includes data ingestion engine 125, response curve generator 130, long-term impact correction engine 140, allocation service analytics computation model 145, optimization and simulation engine 150, and data analytics user interface.

With reference to FIG. 1B-1E, FIG. 1B-1E illustrate aspects—schema representations—associated with providing a marketing budget allocation service associated with an optimization and simulation engine in a data analytics system. At high level, the marketing budget allocation engine can perform marketing budget allocation engine operations that are associated the following processing stages: data preparation, data feed and refresh, modelling assumptions, run model, model selection and validation, allocation, and output.

As discussed above, conventional data analytics systems for budget allocation may collect key data; however, estimation methodologies are often associated with manual intervention (e.g., manual input of data or manual selection of models). And, even when a model can be implemented and executed against the data, validation of the model may be lengthy (e.g., several weeks) and delivery of insights is generally limited to contribution to volume data and Return of Investment (ROI). Moreover, output from conventional data analytics systems can be flat output (e.g., a presentation) without actionable items associated with quantified and measurable data.

The marketing budget allocation engine, in contrast, can include automatic access to data (e.g., automatic feed to data and clean data). The marketing budget allocation engine also provides support for modeling assumptions. For example, the marketing budget allocation engine can provide support for a data structure model to factor in prior knowledge (e.g., default impact on sales cannot be negative; default values for duration and intensity of ad-stock; and default values for saturation effect). The marketing budget allocation engine can support running its corresponding model once and learning the parameters based on prior knowledge that has been entered into the marketing budget allocation engine. Moreover, with an analytics computation model framework applied in this context, validation of the model is significantly expedited (e.g., a few days).

The marketing budget allocation engine can provide optimized allocation at brand or product portfolio level and further support output data based on a user interface that is fully customized allowing to generate, optimize, and simulate scenarios. The marketing budget allocation engine can operate using different types of datasets. Datasets (i.e., marketing budget allocation data) can include information related to processes that a company undertakes to engage its target audience, build strong relationships to create value in order to capture value in return. Marketing budget allocation data can be associated with spending or execution metrics corresponding to media, visibility and events, and promotions, and sales, market data (e.g., distribution and competition) and brand (e.g., brand equity, awareness, and consideration).

The marketing budget allocation engine can operate using data processing engines in the pipeline: short-term sellout contribution engine, long-term discrimination engine, and constraints and scenarios engine. The short-term sellout contribution engine can perform operations associated with sales or panel sellout (e.g., weekly Nielsen information), spend and execution data (e.g., media visibility, events), promo spend (e.g., price cuts, displays) or consumer incentives data (e.g., coupons). The long-term discrimination engine can perform operations associated with potential of brands (e.g., pushing brands with highest potential), crisis-event-distorted forecast (e.g., by demand space or category, through search, footfall, etc.) and consumer surveys (e.g., touchpoint impact on purchase probability or to strengthen brand attributes and equity). The constraints and scenarios engine can perform operations associated with business objectives (e.g., maximize topline sales/bottom line profit) and long-term (brand equity) or short-term (sales) perspectives. Allocation solver/tool can provide an interface that presents results data by brand or by touchpoint.

Turning to FIG. 1B, FIG. 1B illustrates a high level architecture for providing a marketing budget allocation service associated with an optimization and simulation engine in a data analytics system. Datasets 120 of FIG. 1A can be associated with data sources and associated with data governance 122. Data sources can be associated with data from agencies, internal systems and external data sources, where the data is processed (e.g., cleaned) periodically to identify spend information at brand level. Spend information can correspond to sales, traditional media campaign spend, digital campaigns spend, customer relationship management campaigns, price discounts and other offers. Data governance operations (e.g., managing the availability, usability, integrity and security of data from the data sources) can also be performed. An automated cleanser 124 can be associated with the data ingestion engine 125 of FIG. 1 to provide operations associated, for example, with identifying and resolving corrupt, inaccurate, or irrelevant data.

At a high level, the marketing budget allocation service is associated with data platform 112, marketing impact models 114, optimization engines 116, and a web app 118 to support the functionality described herein. In particular, the data platform 112 of the marketing budget allocation engine 110 stores data for all markets the right granularity with right data model in data repositories. The data ingestion engine 125 of FIG. 1A can support a process of testing input data for compliance against a flexible data model to generate validated model inputs 126 that are communicated for processing. The industrialized marketing impact models 114 include analytic models that identify the impact of marketing per brand and per touchpoint based on measuring the impact of spend on sales and brand equity, where results data can be provided via graphical user interface visualizations.

The optimization engines 116, by way example, can operate to optimize for earnings before taxes, interest, depreciation and amortization (EBTIDA) or sales including short-term, long-term objectives and local constraints. For example, prior hypothesis input data, inputs of local or global objectives and constraints can be received and processed via the optimization engines 116 that propose allocation fitting for the local and global constraints. The user interface 118 is configured to collect user inputs and visualize results via a data analytics interface, where the results include allocation per brand and touchpoint and corresponding financial Key Performance Indicators (KPIs). User interface 118 can be associated with an type of application (e.g., web application) with a user interface that facilitates user interactions with the marketing budget allocation service.

As shown in FIG. 1C, advantageously, the marketing budget allocation service provides a platform that is scalable and transparent in operations and interfaces, in contrast to conventional marketing mix modeling (MMM) approaches. The market budget allocation service described herein is based on a service pipeline that includes a set of allocation intelligence data processing engine that are used to generate output that is managed (e.g., visualized, presented, and revised) using a data analytics user interface. The service pipeline includes data preparation, data feed and refresh, modeling assumptions, run model, model selection and validation, allocation engine, an output that improves on marketing mix modeling approaches via probabilistic programming.

The marketing budget allocation service can provide: (1) scalability in that it removes the burden of a manual selection process, burden of redoing bespoke data preparation at every refresh, and reduced effort in adding recent data to new to touchpoints; (2) transparency by allowing the incorporation of domain expertise and user beliefs through priors and model structure (e.g., priors are the default values when data is not informative enough; modeling structure can be adapted to incorporate relevant effect) and transparent model selection based on business input written in the code; (3) performance and reliability in that the service operates in contexts with low amounts of data, protects from aberrant results as priors act as guardrails in the absence of data, offers joint estimation of parameters including their dependencies; and (4) decision-focused under uncertainty in that the service provides most probable values of parameters, but also quantifies uncertainty in estimations and leverages stochastic optimization and propagates uncertainty down to actual allocation decisions.

Turning to FIG. 1D, FIG. 1D illustrates a high level schematic 190A of the marketing budget allocation service features (i.e., data cube 190, short-term sellout contribution 192, long-term discrimination 194, constraints and scenarios 196, and allocation solver/tool 198). The data cube 190 supports representing data along different dimensions of interest (e.g., advertising and marketing spend, sales and brand). The short-term contribution 192 (ROI factory) including panel sellout, market data, advertising and promotion spend, promo spend and long-term discrimination including potential of brands, crisis-event-distorted forecast, consumer surveys. Constraints and scenarios can include business objectives, and long-term and short-term perspectives. The allocation solver tool can include interfaces that support presenting results data include allocation by brand and allocation by touchpoint.

Turning to FIG. 1E, FIG. 1E illustrates a high level schematic 190C of the marketing budget allocation service operations, for example,—via continuous iterations—including processing historical data, setting parameters for strategic inputs, creating and running scenarios, personalizing constraints, and validating reference scenarios. (1) Processing historical data can include ensuring relevant data are used and determining what was activated in the past; (2) setting parameters for strategic inputs can include ensuring the right strategic choices are inputted within the marketing budget allocation service (e.g., category forecast, potential of brands, and brand equity); (3) creating and running scenarios can include creating scenarios, consulting results, and comparing scenarios; (4) personalizing constraint can include refining scenarios business and advertising and marketing spend constraints; and (5) validating reference scenario can include validating scenario used for allocation and advertising and spend.

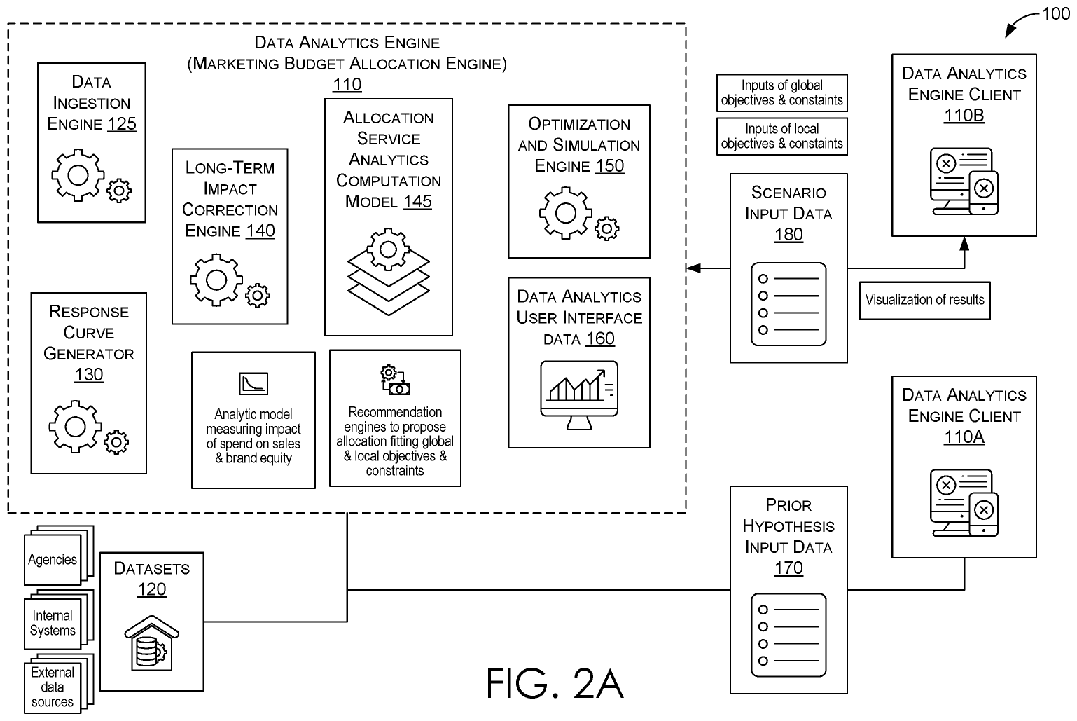

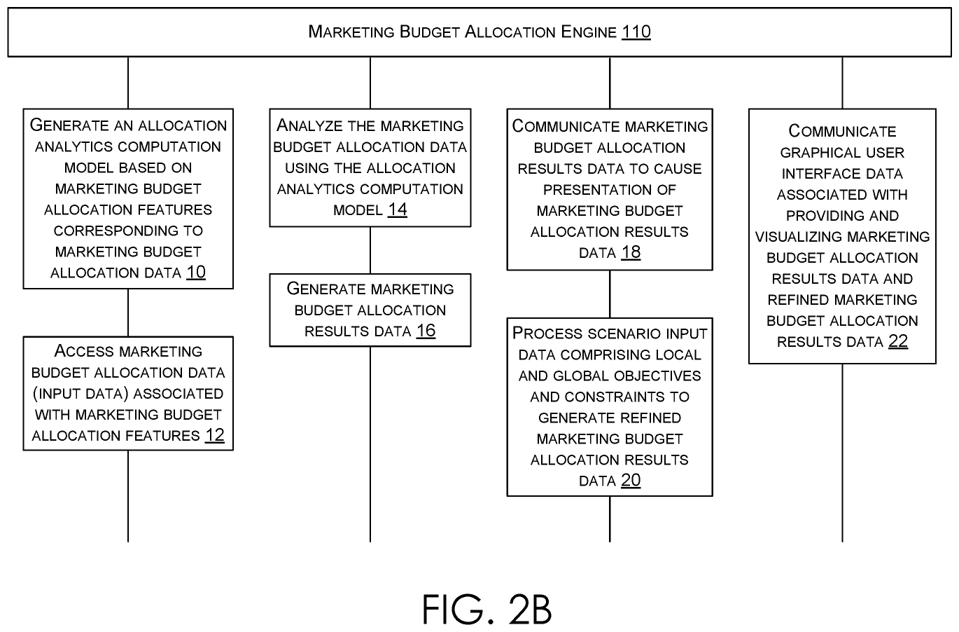

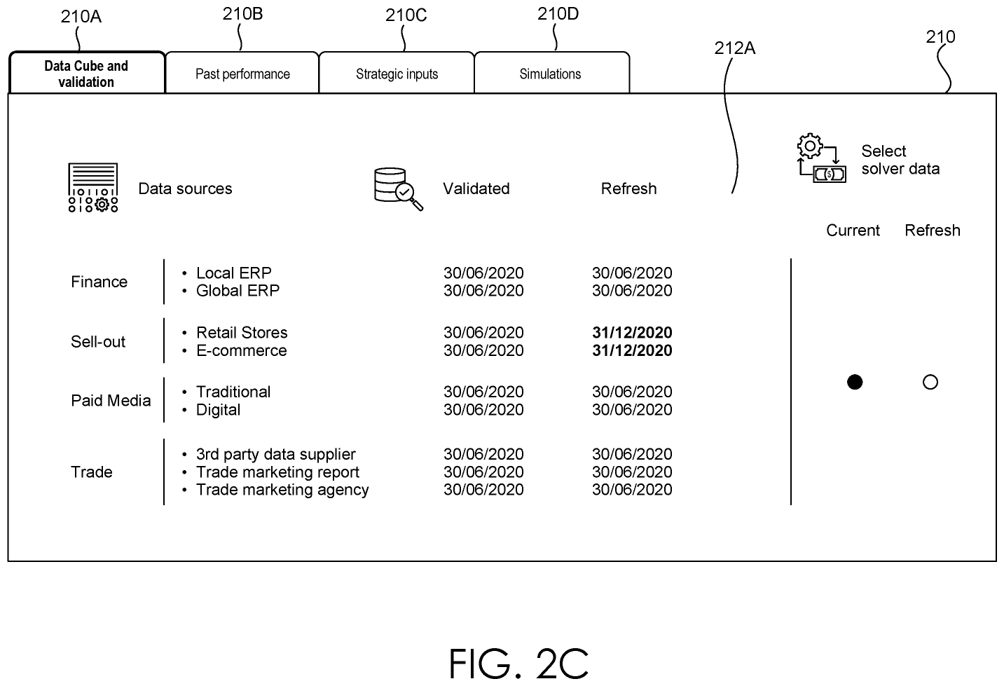

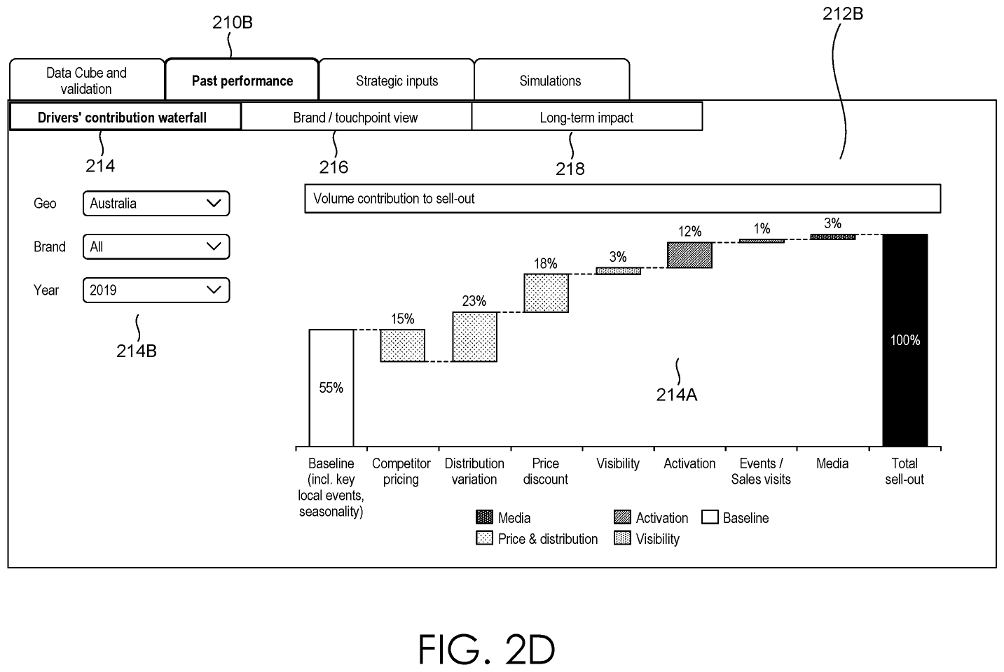

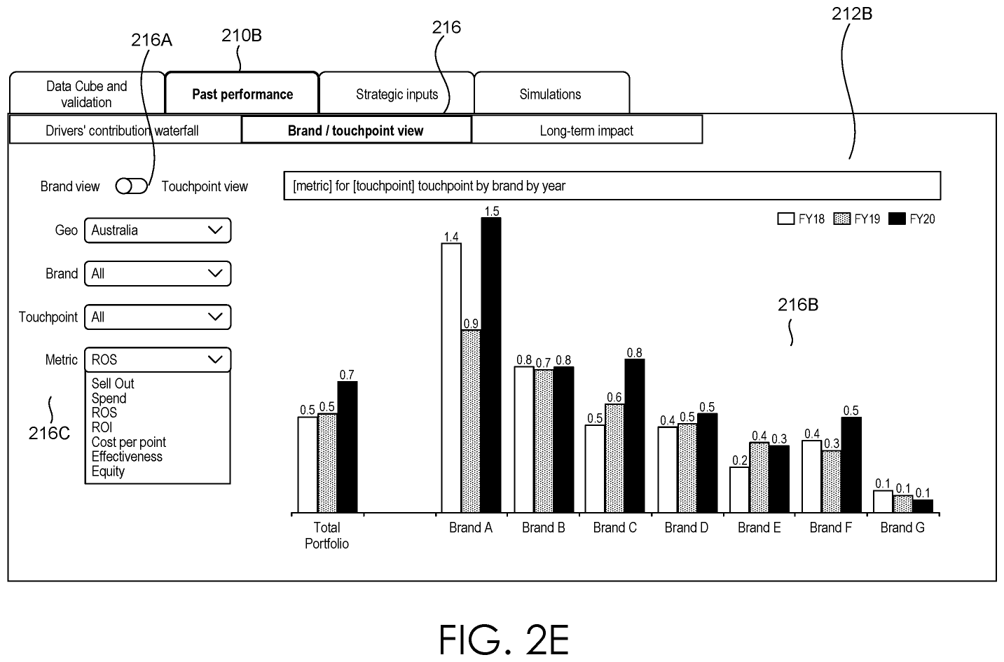

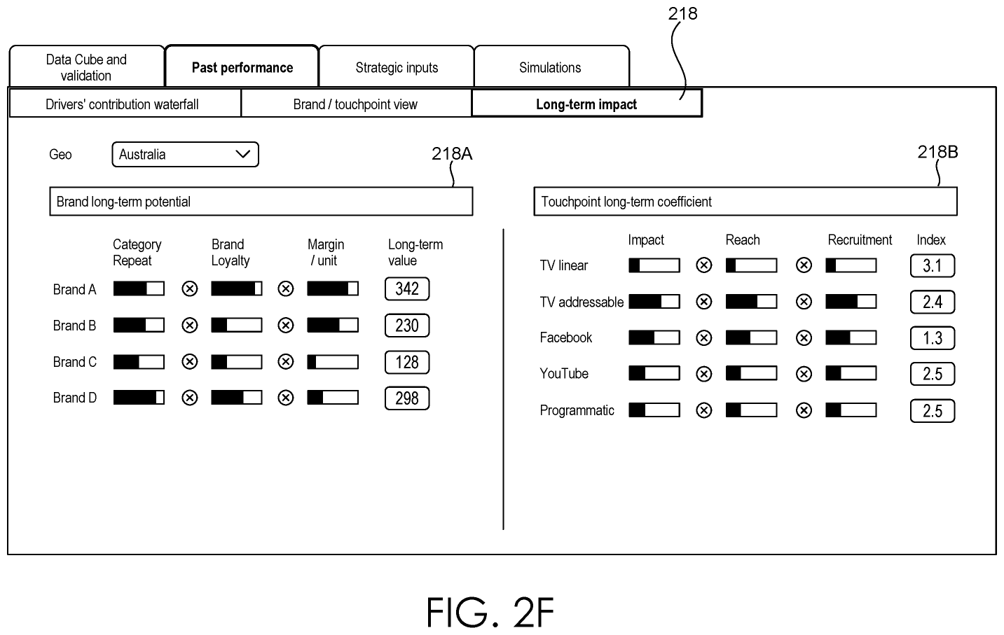

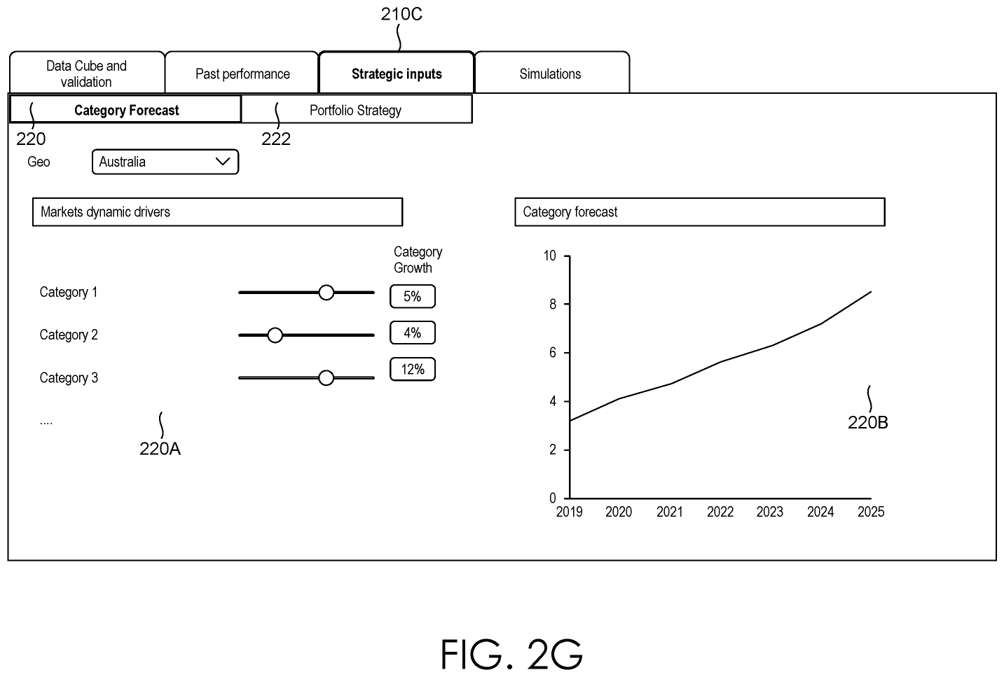

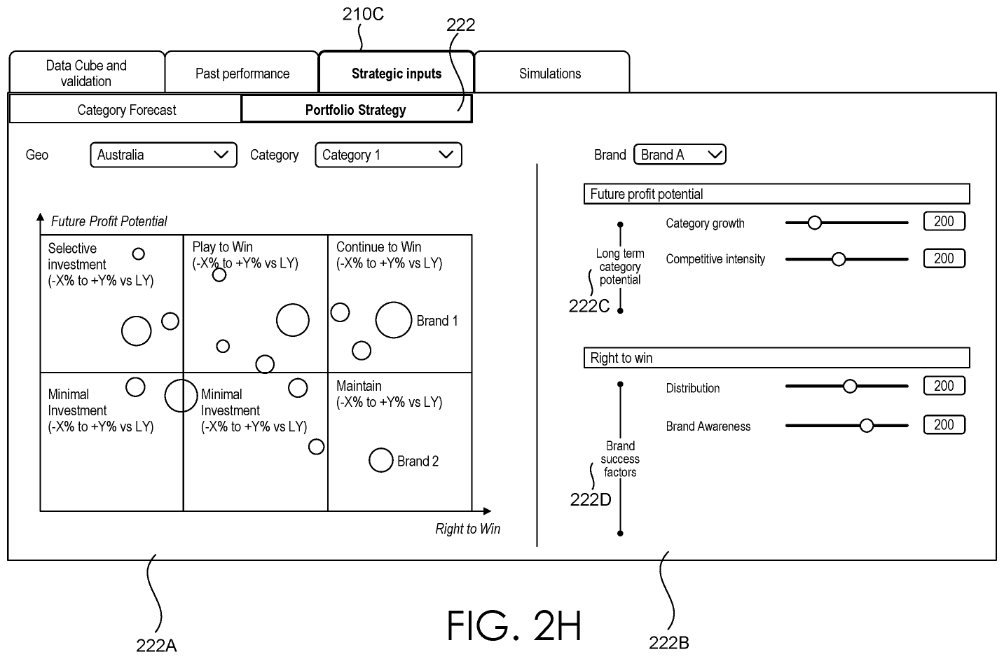

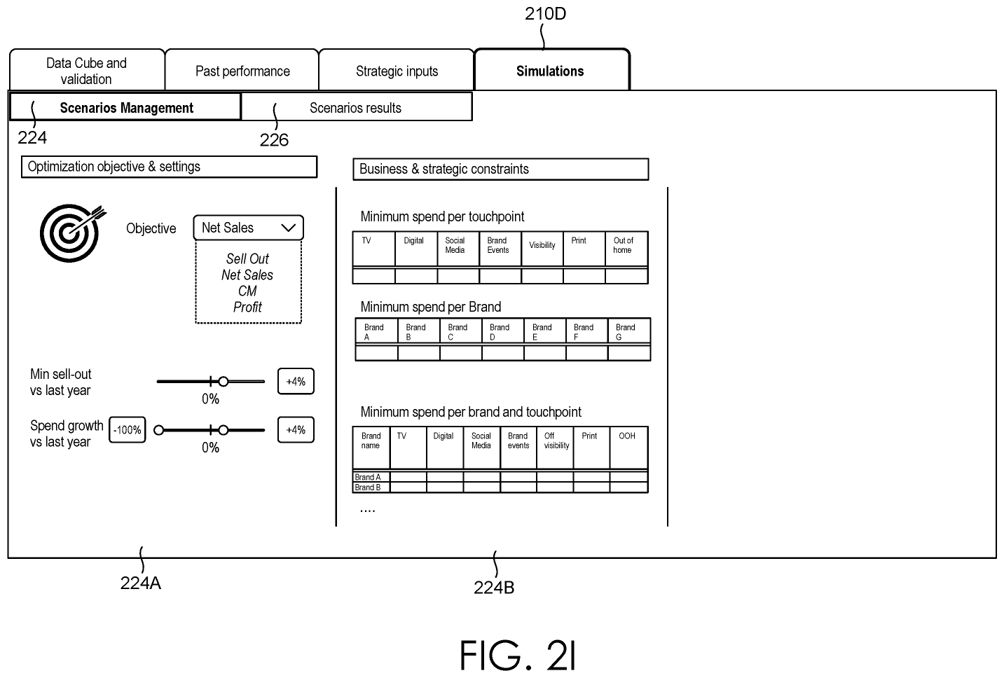

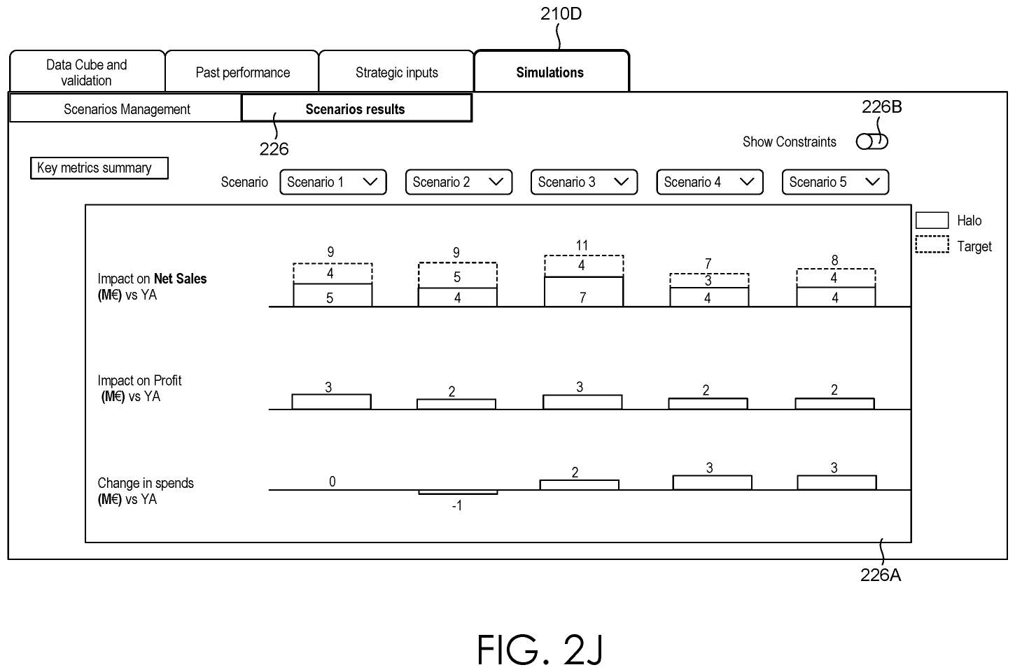

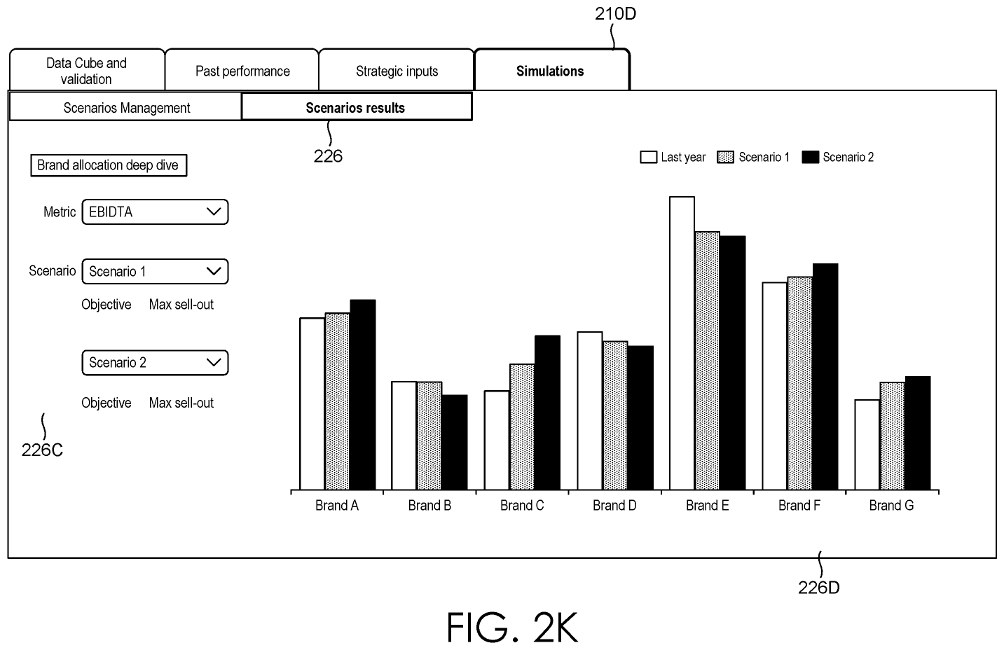

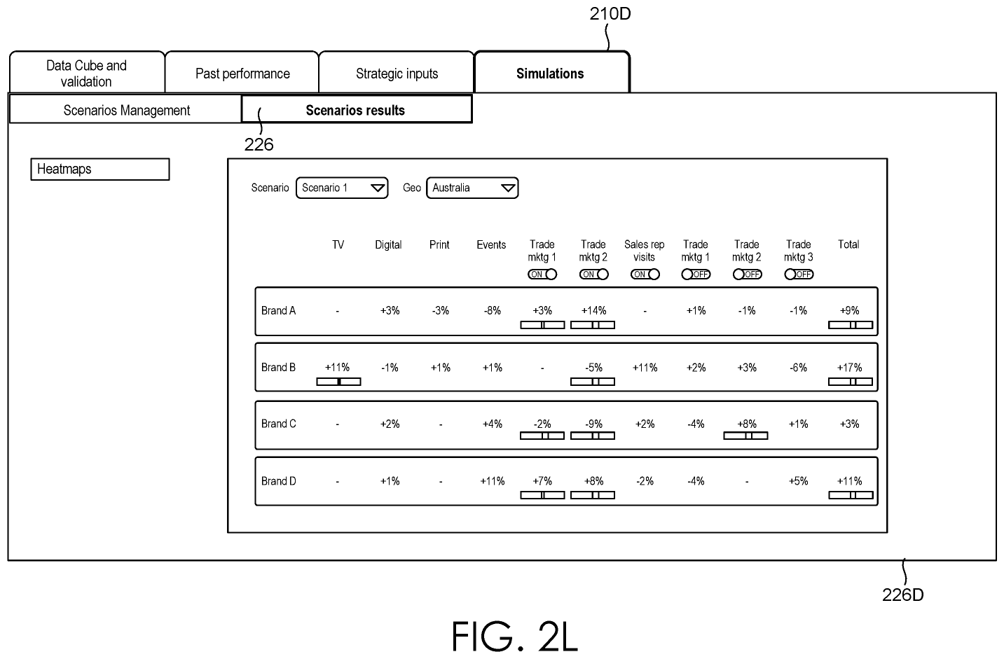

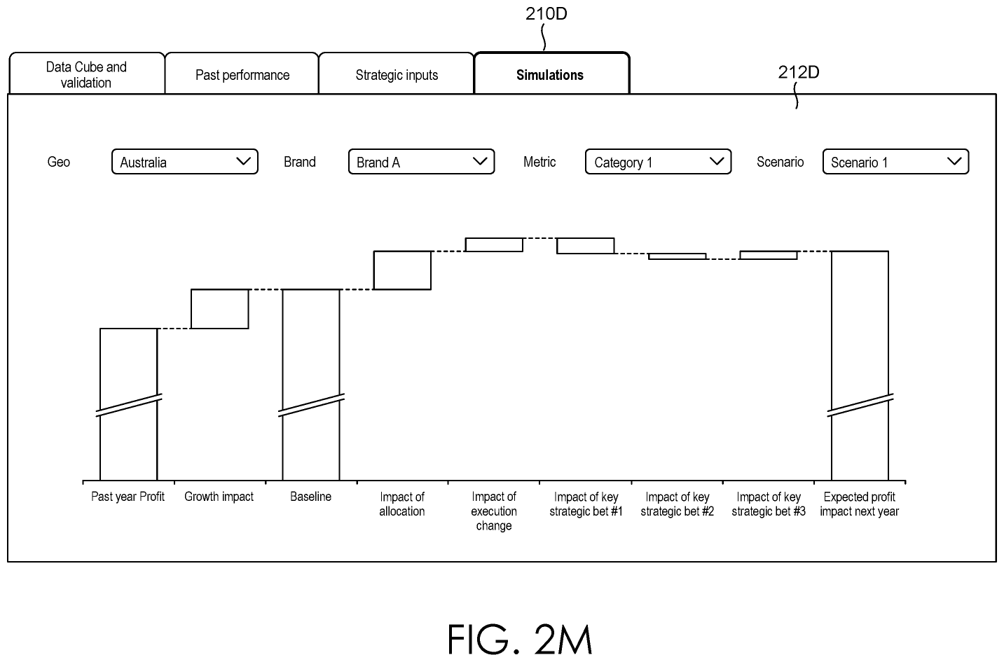

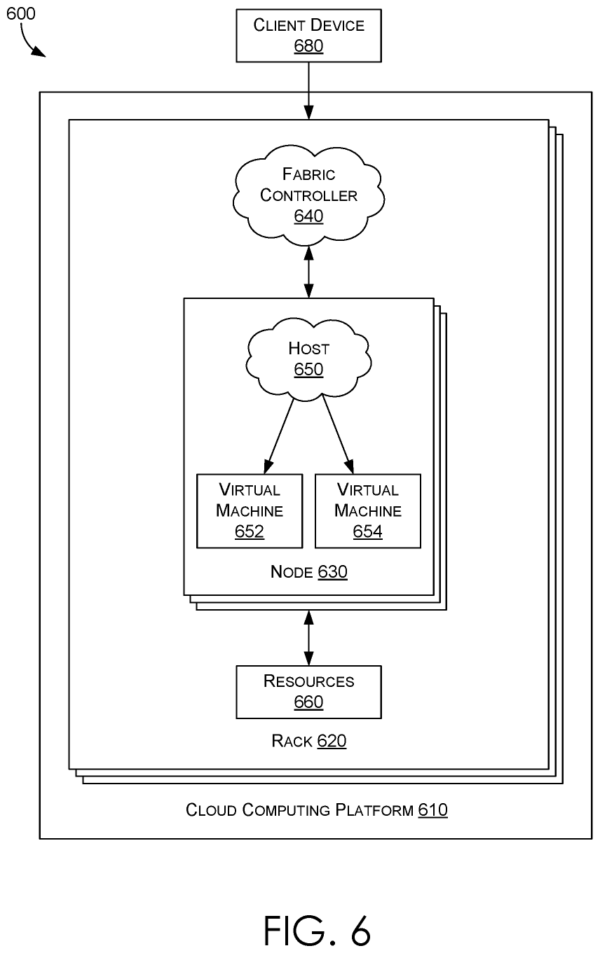

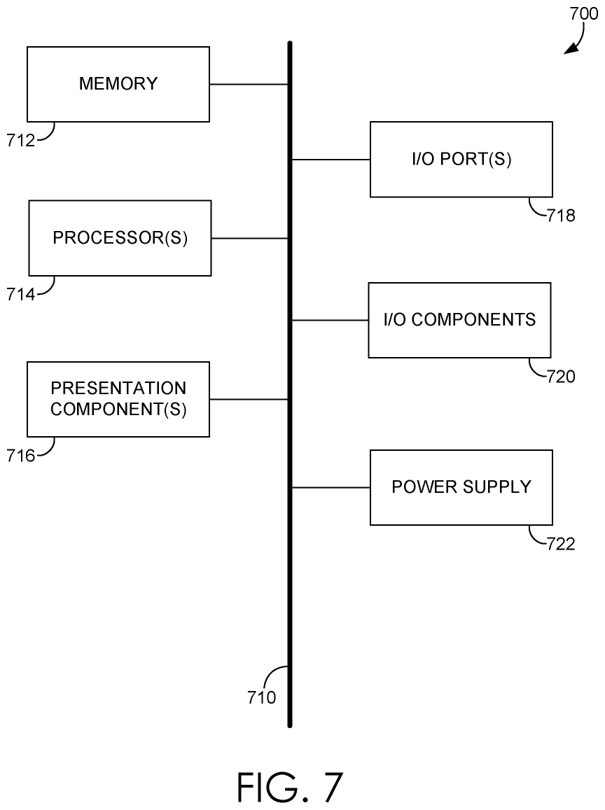

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally, the technical solution environment includes a technical solution system suitable for providing the example data analytics system 100 in which methods of the present disclosure may be employed. In particular, FIG. 2A shows a high level architecture of the data analytics system 100 in accordance with implementations of the present disclosure. Among other engines, managers, generators, selectors, or components not shown (collectively referred to herein as “components”), the technical solution environment of data analytics system 100 corresponds to FIGS. 1A and 1B.

With reference to FIG. 2A, FIG. 2A illustrates data analytics system 100 FIG. 1A illustrates a data analytics system 100 including data analytics engine 110 (i.e., marketing budget allocation engine 110), data analytics engine client 110A (e.g., administrator client), and data analytics engine client 110B (e.g. end-user client), and datasets 120 (e.g., agencies, internal systems, external data sources). The data analytics engine 110 further includes data ingestion engine 125, response curve generator 130, long-term impact correction engine 140, allocation service analytics computation model 145 (e.g., analytic model measuring impact of spend on sales and brand equity and recommendation engine propose allocation fitting global and local objectives and constraints), optimization and simulation engine 150, and data analytics user interface.

Operationally, at a marketing budget allocation engine 110, marketing budget allocation data associated with marketing budget allocation features is accessed. Accessing the marketing budget allocation data further comprises accessing marketing data from datasets and accessing prior hypothesis input data. The marketing budget allocation data is analyzed using an allocation service analytics computation model. The allocation service analytics computation model is trained based on marketing budget allocation features corresponding to the market budget allocation data. The allocation service analytics computation model is configured to generate marketing budget allocation results data. The allocation service analytics computation model is generated based on both short-term sellout contribution data and long-term discrimination data.

Based on analyzing the marketing budget allocation data, marketing budget allocation results data is generated. The marketing budget allocation results data includes a return on investment (ROI) report associated with one or more touchpoints of a brand. The ROI report comprises ROI curves per unit of a selected currency, the ROI curves indicate how much incremental volume results from an additional unit of currency on the touchpoint or the brand. The marketing allocation results data is caused to be presentation on a data analytics user interface. Presenting the marketing budget results data further comprises presenting a plurality of interactive graphical user interfaces associated with data validation, past performance, strategic inputs, simulations, brand and touchpoint views, short-term and long-term impact.

An optimization and simulation engine user interface of the marketing budget allocation engine 110 supports collecting scenario input data associated with the marketing budget allocation results data. The optimization and simulation engine user interface further supports processing scenario input data comprising local and global objectives and constraints to generate refined marketing budget allocation results data corresponding to the local and global objectives and constraints. The optimization and simulation engine user interface engine also supports a first graphical user interface associated with providing marketing budget allocation results data by brand and a second graphical user interface associated with providing marketing budget allocation results data by touchpoint.

With reference to FIG. 2B, FIG. 2B illustrates providing a marketing budget allocation service associated with an optimization and simulation engine in a data analytics system. At block 10, generate an allocation computation model based on marketing budget allocation features corresponding to marketing budget allocation data. At block 12, access marketing allocation data (input data) associated with marketing budget allocation features. At block 14, analyze the marketing budget allocation data using the allocation service analytics computation model. At block 16, generate marketing budget allocation results data. At block 18, communicate marketing budget allocation results data to cause presentation of the marketing budget allocation results data. At block 20, process scenario input data comprising local and global objectives and constraints to generate refined marketing budget allocation results data. At block 22, communicate graphical interface data associated with providing and visualizing marketing budget allocation results data and refined marketing budget allocation results data.

With reference to FIGS. 2C-2I, FIG. 2C-2I illustrates aspects—interface representations—associated with the marketing budget allocation engine 110, optimization and simulation engine 150, data analytics user interface data 160, and data analytics engine client 110B. At a high level, the marketing budget allocation engine operates to generate the data analytics user interface data 160 that includes user interface elements, marketing budget allocation results data and refined marketing budget allocation results data and support interactions between users and the data analytics system. User interfaces allow effective operation and control by users while the data analytics system simultaneously performs computing operations. Interface data can include graphical user interfaces that allow users to interact with the data analytics system (e.g., marketing budget allocation tool) through graphical user interface elements. A graphical user interface can include a dashboard that provides a visual display of data (e.g., data analytics user interface data).

With reference to FIGS. 2C, FIG. 2C illustrates a data analytics user interface for presenting marketing budget allocation data (e.g. results data and refined results data). The data analytics user interface can include a dashboard associated with a plurality of tabs (e.g., data cube and validation 210A, past performance 210B, strategic inputs 210C, and simulations 210D tabs) that are selectable to provide marketing budget allocation data associated with the corresponding tabs. For example, data cube and validation 210A can include a data cube and validation interface portion 212A that identifies data sources (e.g., finance, sell-out, paid media, and trade) validation dates, and refresh dates) and as shown in FIG. 2M, simulations 210D can include a simulations interface portion 212D that identifies simulation data (e.g., selectable attributes for geography, brand, metric, and scenario and corresponding waterfall chart visualization associated with selected attributes and the simulation data).

As shown in FIG. 2D, past performance 210B can include a past performance interface portion 212B having tabs (i.e., drivers' contribution waterfall 214, brand/touchpoint view 216, and long-term impact 218) that are selectable to provide marketing budget allocation data associated with the corresponding tabs. For example, driver' contribution waterfall 214 can include waterfall chart 214A—a data visualization that helps in understanding the cumulative effect of sequentially introduced positive or negative values. Waterfall charts can include multiple total columns and values that cross the axis. Increments and decrements that are sufficiently extreme can cause the cumulative total to fall above and below the axis at various points. Intermediate subtotals, depicted with whole columns, can be added to the graph between floating columns. The waterfall chart 214 can be associated with a plurality of filters 214B that support selecting attributes (e.g., geographic location, brand, and year) that are used to determine marketing budget allocation data to be presented via the waterfall chart 214A or the past performance interface portion 212B.

Turning to FIG. 2E, FIG. 2E illustrates brand/touchpoint 216 tab having a selectable option picker 216A (e.g., brand view and touchpoint view) that can be selected to toggle a view on the past performance interface portion between brand view and touchpoint view. The brand view or touchpoint view can be associated with a data visualization 216B (e.g., bar charts) and a plurality of filters 216C that support selecting attributes (e.g., geographic location, brand, touchpoint, and metric) that are used to determine marketing budget allocation data to be presented via the data visualization 216B or the past performance interface portion 212B. And, FIG. 2F, 2F illustrates long-term impact 218 tab having a brand long-term potential interface portion 218A and touchpoint long-term coefficient interface portion 218B. The brand long-term potential interface portion 218A supports presenting a plurality of brands and long-term potential attributes and corresponding values as text, numbers, or graphical visualizations. The touchpoint long-term coefficient 218B also supports presenting a plurality of touchpoints and long-term coefficient attributes and corresponding values as text, numbers, or graphical visualizations.

Turning to FIG. 2G, FIG. 2G illustrates strategic inputs 210C having category forecast 220 tab and portfolio strategy 222 tab. The category forecast 220 tab is associated with a markets dynamic driver interface portion 220A and a category forecast 220B interface portion 220B. And, as shown in FIG. 2H, the portfolio strategy 222 tab is associated with a category interface portion 222A with a future profit potential and right to win graphical visualization; and a brand interface portion 222B with a first set of long term category potential sliders 222C corresponding to attributes of future profit potential data and a second set of brand success factors sliders 222D corresponding to attributes of right to win data.

Turning to FIG. 2I, FIG. 2I illustrates simulations 210D having scenario management 224 tab and scenarios results 226 tab. The scenarios management 224 tab is associated with optimization objective and settings interface portion 224A and business and strategic constraints interface portion 224B. The optimization objective and settings interface portion 224A includes a first plurality of sliders and strategic constraints interface portion 224B include a plurality of tables that provide marketing budget allocation scenario management data. And, FIG. 2J, FIG. 2J illustrates scenarios results 226 tab associated with scenario results key metrics summary interface portion 226 and a selectable option picker 226B to show or not show constraints. FIG. 2K illustrates a plurality of filters 226C that support selecting attributes that are used to determine which scenario results data to present; and further illustrates graphical visualizations interface portion 226D including graphical visualizations (e.g., bar charts) for presenting the scenario results data; and FIG. 2L illustrates brands data interface portion for presenting scenario results data associated with particular brands.

### Exemplary Methods

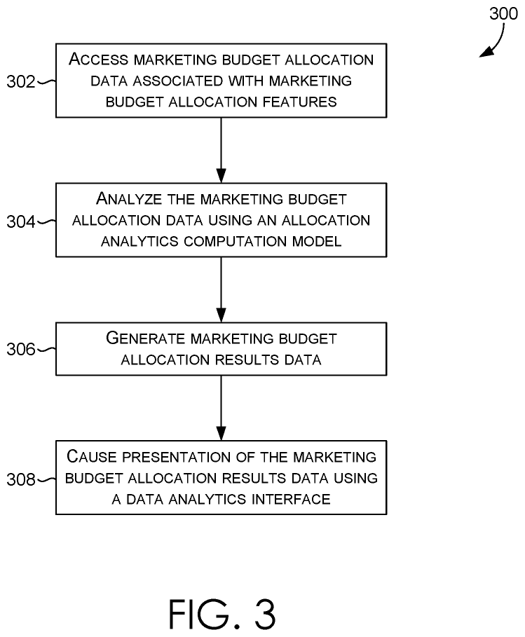

With reference to FIGS. 3, 4 and 5, flow diagrams are provided illustrating methods providing a marketing budget allocation service associated with an optimization and simulation engine in a data analytics system. The methods may be performed using the data analytics system described herein. In embodiments, one or more computer-storage media having computer-executable or computer-useable instructions embodied thereon that, when executed, by one or more processors can cause the one or more processors to perform the methods (e.g., computer-implemented method) in the data analytics system (e.g., a computerized system or computing system).

Turning to FIG. 3, a flowing diagram is provided that illustrates a method 300 for providing a marketing budget allocation service associated with an optimization and simulation engine in a data analytics system. the marketing budget allocation service is provided—via a data analytics engine—based on a data ingestion engine, a response curve generator, a long-term impact correction engine, an optimization and simulation engine and a data analytics user interface. At block 302, access marketing allocation budget allocation data with marketing budget features. Marketing budget allocation includes identifying an amount of a budget per product (or brand) and touchpoints—ways a business interacts with (potential) customers—that maximize financial key performance indicators (KPIs) (e.g., volume, sales, margin) under certain business constraints (e.g., budget, cost, evolutions, consumer behaviors, and strategic intent).

At block 304, analyze the marketing budget allocation data using an allocation service analytics computation model. The allocation service analytics computation model is generated based on both short-term sellout contribution data and long-term discrimination data associated with probabilistic programming and mixed integer programming. For example, the response curve generator leverages probabilistic programming associated with statistical modeling, probabilistic modeling (e.g., Bayesian modelling), or machine learning.

At block 306, generate marketing budget allocation results data comprising a return on investment (ROI) report associated with one or more touchpoints of a brand. The ROI report comprises ROI curves per unit of a selected currency, the ROI curves indicate how much incremental volume results from an additional unit of currency on the touchpoint or the brand. By way of illustration, the main output of the response model, response curves are the pairs of points (spend, incremental volume) for a specific brand and touchpoint pair, allowing to build the incremental volume due to different levels of spend. By default, response curves are defined as the incremental volume response to spend, but it can also be the response in revenue, or in financial metrics such as ROI.

At block 308, cause presentation of the marketing budget allocation results data using a data analytics interface. Presenting the marketing budget results data further comprises presenting a plurality of interactive graphical user interfaces associated with data validation, past performance, strategic inputs, simulations, brand and touchpoint views, short-term and long-term impact. An optimization and simulation engine user interface of the marketing budget allocation engine supports collecting scenario input data associated with the marketing budget allocation results data, the scenario input data comprising local and global objectives and constraints to generate refined marketing budget allocation results data corresponding to the local and global objectives and constraints. The optimization and simulation engine user interface of the marketing budget allocation engine further supports a first graphical user interface associated with providing marketing budget allocation results data by brand and a second graphical user interface associated with providing marketing budget allocation results data by touchpoint.

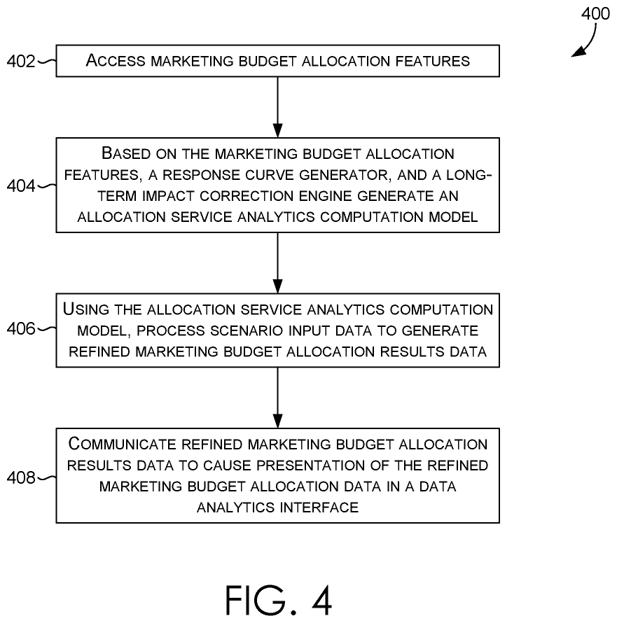

Turning to FIG. 4, a flowing diagram is provided that illustrates a method 400 for providing a marketing budget allocation service associated with an optimization and simulation engine in a data analytics system. At block 402, access marketing budget allocation features. At block 404, based on the marketing budget allocation features, a response curve generator, and a long-term impact correction engine, generate an allocation service analytics computation model. At block 406, using the allocation service analytics computation model, process scenario input data to generate refined marketing budget allocation results data. At block 408, communicate refined marketing budget allocation results data to cause presentation of the refined marketing budget allocation data in a data analytics interface.

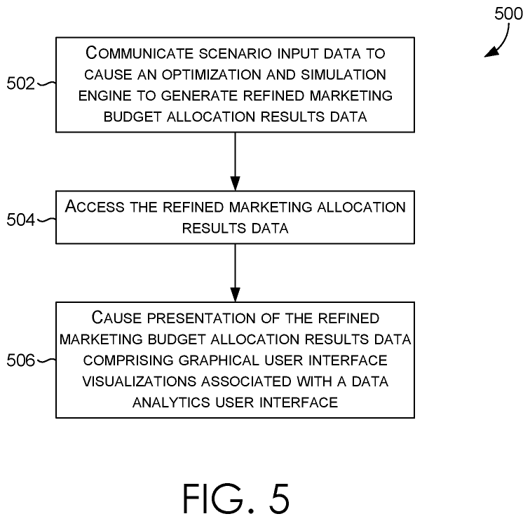

Turning to FIG. 5, a flowing diagram is provided that illustrates a method 500 for providing a marketing budget allocation service associated with an optimization and simulation engine in a data analytics system. At block 502, communicate scenario data to cause an optimization and simulation engine to generate refined marketing budget allocation results data. At block 504, access the refined marketing allocation results data. At block 506, cause presentation of the refined marketing budget allocation results data comprising graphical user interface visualizations associated with a data analytics user interface.

### Additional Support for Detailed Description of the Invention

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) running a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Computing Environment

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations comprising:
accessing, at a marketing budget allocation engine, marketing budget allocation data associated with marketing budget allocation features;
analyzing the marketing budget allocation data using an allocation service analytics computation model, wherein the allocation service analytics computation model is trained based on marketing budget allocation features corresponding to the market budget allocation data, wherein the allocation service analytics computation model is configured to generate marketing budget allocation results data;
based on analyzing the marketing budget allocation data, generating marketing budget allocation results data comprising a return on investment (ROI) report associated with one or more touchpoints of a brand; and
communicating the marketing allocation results data to cause presentation of the marketing budget allocation results data using a data analytics user interface.

2. The computerized system of claim 1, wherein accessing the marketing budget allocation data further comprises accessing marketing data from datasets and accessing prior hypothesis input data.

3. The computerized system of claim 1, wherein the allocation service analytics computation model is generated based on both short-term sellout contribution data and long-term discrimination data associated with probabilistic programming and mixed integer programming.

4. The computerized system of claim 1, wherein presenting the marketing budget results data further comprises presenting a plurality of interactive graphical user interfaces associated with data validation, past performance, strategic inputs, simulations, brand and touchpoint views, short-term and long-term impact.

5. The computerized system of claim 1, wherein the ROI report comprises ROI curves per unit of a selected currency, the ROI curves indicate how much incremental volume results from an additional unit of currency on the touchpoint or the brand.

6. The computerized system of claim 1, wherein an optimization and simulation engine user interface of the marketing budget allocation engine supports collecting scenario input data associated with the marketing budget allocation results data, the scenario input data comprising local and global objectives and constraints to generate refined marketing budget allocation results data corresponding to the local and global objectives and constraints.

7. The computerized system of claim 1, wherein an optimization and simulation engine user interface of the marketing budget allocation engine supports a first graphical user interface associated with providing marketing budget allocation results data by brand and a second graphical user interface associated with providing marketing budget allocation results data by touchpoint.

8. One or more computer-storage media having computer-executable instructions embodied thereon that, when executed by a computing system having a processor and memory, cause the processor to:
access, at a marketing budget allocation engine, marketing budget allocation data associated with marketing budget allocation features;
analyze the marketing budget allocation data using an allocation service analytics computation model, wherein the allocation service analytics computation model is trained based on marketing budget allocation features corresponding to the market budget allocation data, wherein the allocation service analytics computation model is configured to generate marketing budget allocation results data;
based on analyzing the marketing budget allocation data, generate marketing budget allocation results data comprising a return on investment report (ROI) associated with one or more touchpoints of a brand; and
communicate the marketing allocation results data to cause presentation of the marketing budget allocation results data using a data analytics user interface.

9. The media of claim 8, wherein accessing the marketing budget allocation data further comprises accessing marketing data from datasets and accessing prior hypothesis input data.

10. The media of claim 8, wherein the allocation service analytics computation model is generated based on both short-term sellout contribution data and long-term discrimination data associated with probabilistic programming and mixed integer programming.

11. The media of claim 8, wherein presenting the marketing budget results data further comprises presenting a plurality of interactive graphical user interfaces associated with data validation, past performance, strategic inputs, simulations, brand and touchpoint views, short-term and long-term impact.

12. The media of claim 8, wherein the ROI report comprises ROI curves per unit of a selected currency, the ROI curves indicate how much incremental volume results from an additional unit of currency on the touchpoint or the brand.

13. The media of claim 8, wherein an optimization and simulation engine user interface of the marketing budget allocation engine supports collecting scenario input data associated with the marketing budget allocation results data, the scenario input data comprising local and global objectives and constraints to generate refined marketing budget allocation results data corresponding to the local and global objectives and constraints.

14. The media of claim 8, wherein an optimization and simulation engine user interface of the marketing budget allocation engine supports a first graphical user interface associated with providing marketing budget allocation results data by brand and a second graphical user interface associated with providing marketing budget allocation results data by touchpoint.

15. A computer-implemented method, the method comprising:
accessing, at a marketing budget allocation engine, marketing budget allocation data associated with marketing budget allocation features;
analyzing the marketing budget allocation data using an allocation service analytics computation model, wherein the allocation service analytics computation model is trained based on marketing budget allocation features corresponding to the market budget allocation data, wherein the allocation service analytics computation model is configured to generate marketing budget allocation results data;
based on analyzing the marketing budget allocation data, generating marketing budget allocation results data comprising a return on investment (ROI) report associated with one or more touchpoints of a brand; and
communicating the marketing allocation results data to cause presentation of the marketing budget allocation results data using a data analytics user interface.

16. The method of claim 15, wherein the allocation service analytics computation model is generated based on both short-term sellout contribution data and long-term discrimination data associated with probabilistic programming and mixed integer programming.

17. The method of claim 15, wherein presenting the marketing budget results data further comprises presenting a plurality of interactive graphical user interfaces associated with data validation, past performance, strategic inputs, simulations, brand and touchpoint views, short-term and long-term impact.

18. The method of claim 15, wherein the ROI report comprises ROI curves per unit of a selected currency, the ROI curves indicate how much incremental volumes results from an additional unit of current on the touchpoint or the brand.

19. The method of claim 15, wherein an optimization and simulation engine user interface of the marketing budget allocation engine supports collecting scenario input data associated with the marketing budget allocation results data, the scenario input data comprising local and global objectives and constraints to generate refined marketing budget allocation results data corresponding to the local and global objectives and constraints.

20. The method of claim 15, wherein an optimization and simulation engine user interface of the marketing budget allocation engine supports a first graphical user interface associated with providing marketing budget allocation results data by brand and a second graphical user interface associated with providing marketing budget allocation results data by touchpoint.
